(19) United States
(12) Patent Application Publication
(10) Pub. No.: US 2023/0399755 A1
(43) Pub. Date: Dec. 14, 2023

(54) HYBRID HEAT MANAGEMENT FOR HYDROGEN ELECTROLYZER

(71) Applicant: X Development LLC, Mountain View, CA (US)

(72) Inventors: Alex Grauberger, Palo Alto, CA (US); Radu Gogoana, Brisbane, CA (US); Matthew Forkin, San Mateo, CA (US)

(21) Appl. No.: 17/835,354

(22) Filed: Jun. 8, 2022

(51) Int. Cl. C25B 1/04; C25B 15/08; C25B 9/17; C25B 9/67; C25B 15/027; C25B 15/021; C25B 9/65

(52) U.S. Cl. CPC C25B 1/04; C25B 15/083; C25B 9/17; C25B 9/67; C25B 15/027; C25B 15/021; C25B 9/65

(57) ABSTRACT

A technique for electrolysis includes applying a voltage across anode and cathode electrodes bathed in an electrolytic solution disposed within a plurality of hydrogen electrolyzer cells, venting hydrogen gas produced in cathode chambers of the hydrogen electrolyzer cells to a hydrogen exhaust manifold, venting oxygen gas produced in anode chambers of the hydrogen electrolyzer cells to an oxygen exhaust manifold, evaporating a portion of the electrolytic solution within at least one of the cathode or anode chambers, and maintaining the electrolytic solution in the hydrogen electrolyzer cells within a steady-state temperature range during the electrolysis based at least in part on an evaporative cooling of the electrolytic solution within the hydrogen electrolyzer cells.

### TECHNICAL FIELD

This disclosure relates generally to hydrogen electrolyzers, and in particular, relates to thermal regulation of hydrogen electrolyzers.

### BACKGROUND INFORMATION

The world's energy demands are projected to rise for the foreseeable future. Renewable sources of energy, such as solar and wind will contribute an increasing portion of these future energy needs. Renewable energy sources will be used to charge batteries, which will replace fossil fuels as a significant energy source for many transportation needs, such as automobile transportation. However, batteries may not provide sufficient energy/power densities to satisfy the needs of certain energy intensive transportation applications such as large craft commercial air travel and trans-oceanic trips. Hydrogen and hydrogen fuel cell technologies can provide the necessary energy density to power even these highest energy demand applications. Synthetic fuels made using hydrogen as a feedstock can also target many end use energy needs that are historically difficult to decarbonize. Examples include high-energy-density fuels required for aviation and shipping, green fuel flexibility for gas turbine power generation, or otherwise. As such, hydrogen-based technologies include the promise to decarbonize what grid based or battery electrification cannot.

Green technologies (e.g., low net carbon or carbon neutral technologies) for commercial production of hydrogen gas currently require immense capital expenditures. These immense capital expenditures are significant barriers to the broad-based adoption of hydrogen fuel cell technologies and hydrogen-based synthetic fuel and the transition to low carbon emitting hydrogen for industrial applications. Commercial scale hydrogen solutions that are capable of significantly reducing these capital expenditures, thus providing plentiful hydrogen at an economically competitive price, may hasten the deployment and adoption of green hydrogen-based technologies.

One factor that contributes to the capital expenditures of commercial scale hydrogen production is the thermal management infrastructure needed to reject heat produced during electrolysis and maintain steady-state operational temperatures. The conversion of water to hydrogen and oxygen through electrolysis has inherent efficiency limitations. The inherent inefficiencies in the electrolysis process generates heat, which must be rejected to maintain steady-state operation and avoid thermal breakdown. Many conventional electrolyzers use electrolysis membranes that isolate the cathode from the anode and prevent explosive combination of the oxygen and hydrogen gases. These membrane electrolyzers typically limit operational temperature to a maximum of 50-70 degree Celsius. Exceeding this range can result in breakdown of the electrolysis membrane, electrode catalysts, and/or catalyst binders resulting in reduced operational efficiencies or even explosive failures.

As such, sufficient heat rejection for steady-state thermal operation is critical. Conventional electrolyzers are typically cooled in a similar manner to an internal combustion engine using liquid coolant that is cycled throughout the system to absorb and carry away excess heat. The coolant is then cycled through a heat exchanger, which transfers the heat to the ambient environment. The heat exchanger may employ passive radiative heat dissipation and/or active convection cooling (e.g., forced air across a radiator). This form of convection cooling is referred to as “indirect” convection cooling since the heat exchanger and connected coolant lines operate as an intermediary between the hydrogen electrolyzer and the forced air convection. The intermediary heat transfer systems can require extensive plumbing, manifolds, and radiators for commercial scale systems all of which contribute to the complexity and high capital expenditures associated with conventional hydrogen electrolyzers.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 is a cross-sectional view illustrating a hydrogen electrolyzer cell, in accordance with an embodiment of the disclosure.

FIG. 2A is a perspective view illustration of a hydrogen electrolyzer stack including five cells stacked in series, in accordance with an embodiment of the disclosure.

FIG. 2B is a perspective view illustration of a hydrogen electrolyzer stack with a side cutout illustrating internal details, in accordance with an embodiment of the disclosure.

FIG. 3 is a perspective exploded view of a modular and extensible panel construction of a hydrogen electrolyzer cell, in accordance with an embodiment of the disclosure.

FIG. 4 is a cross-sectional illustration through a center of the five-cell hydrogen electrolyzer stack, in accordance with an embodiment of the disclosure.

FIG. 5 is a perspective view illustration of an array of stacks of hydrogen electrolyzer cells coupled for large scale hydrogen production, in accordance with an embodiment of the disclosure.

FIG. 6 is a functional block diagram illustrating components for hybrid heat management of a hydrogen electrolyzer system, in accordance with an embodiment of the disclosure.

FIG. 7 is a flow chart illustrating a process of hybrid heat management of a hydrogen electrolyzer system that dynamically leverages direct external convection cooling and internal evaporative cooling to maintain steady-state electrolysis, in accordance with an embodiment of the disclosure.

### DETAILED DESCRIPTION

Embodiments of a system, apparatus, and method of operation for hybrid heat management of a hydrogen electrolyzer system to maintain steady-state electrolysis are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of a hydrogen electrolyzer cell, stack, and system described herein provide a lower-cost option for generation of hydrogen while only modestly trading off efficiency for substantial capital expenditure (CAPEX) savings. The CAPEX savings are derived, in significant part, from integrating a number of expensive, conventionally distinct components into an extensible structure that may be fabricated of low-cost materials, such as injection molded thermoplastic (e.g., polypropylene). CAPEX savings are also derived from the elimination of components such as gaskets, tie rods, and compression plates that are typically used in alkaline electrolyzers. For example, it is believed that a loss of approximately 10% efficiency may be traded for roughly a 10× reduction in CAPEX when compared against conventional alkaline hydrogen electrolyzers. For commercial scale megawatt electrolyzers, this CAPEX savings may mean the difference between economically viable hydrogen production options and uneconomical options that will not be deployed. The high CAPEX of conventional hydrogen electrolyzers often requires that they operate 24/7 with little down time to achieve economic viability. In these scenarios, the use of intermittent green power generation (e.g., solar or wind power) may be precluded and thus the low or zero carbon benefit of hydrogen fuel cells and hydrogen-based synthetic fuels compared to traditional fossil fuels may be reduced or even entirely lost. In contrast, the low cost, scalable nature of the embodiments described herein is expected to be more viable for use with these intermittent green power sources.

Embodiments described herein may also accrue CAPEX savings from the omission of yet another component—an electrolysis membrane. The illustrated embodiments are membraneless electrolyzers, meaning that the electrolysis membrane, through which charged ions transport to sustain the electrochemical processes associated with cathodic reduction and anodic oxidation, is omitted. In other words, the illustrated hydrogen electrolyzers do not separate the electrolytic solution in the cathode and anode chambers from each other using an electrolysis membrane. Rather, the cathode and anode electrodes are bathed in a shared electrolytic solution from a shared reservoir and use chamber geometries and natural buoyancy of the oxygen and hydrogen gases to maintain separation between the evolving oxygen and hydrogen gases. This elimination of the electrolysis membrane can reduce manufacturing expenses (i.e., CAPEX) in trade for more precise control over backpressures during operation.

Yet another design feature that can provide CAPEX savings is the hybrid heat management system used to reject excess heat production and maintain steady-state electrolysis in a steady-state temperature range. The hybrid heat management system may include one or more of a convection cooling system capable of providing direct external convection cooling to the housings of the electrolyzer cells and/or leverage evaporative cooling internally within the anode and cathode chambers of each electrolyzer cell. The combination of the internal evaporative cooling and external direct convection cooling has the potential to provide significant CAPEX savings.

A convection cooling system that blows cooling air directly on the housings of the hydrogen electrolyzer cells provides an exterior, low-cost cooling mechanism that eliminates the need for extensive ducting or interconnecting hoses associated with circulating liquid coolants. The convection cooling system may be actively managed to provide variable cooling based upon feedback from one or more temperature sensors distributed throughout the hydrogen electrolyzer cells. In various embodiments, the housings of the hydrogen electrolyzer cells themselves may include design features (or leverage existing manufacturing features) that stimulate turbulence in the cooling air to improve convective heat transfer and may also provide cooling channels to enable convective cooling from four sides of the cells despite the cells being densely stacked.

The internal evaporative cooling described herein leverages the low-pressure operation of a membraneless electrolyzer where the electrolytic solution is maintained at a fill-level providing a liquid-gas boundary within the anode/cathode chambers of each hydrogen electrolyzer cell. Evaporative cooling transfers heat from the bulk liquid of the electrolytic solution into expelled water vapor when the electrolytic solution is vaporized. This evaporative cooling provides internal cooling directly to the electrolytic solution in a distributed manner. The design and chamber geometries of the membraneless electrolyzer described herein provide significant exposed surface area of the electrolytic solution within each cell. This enables “evaporative” surface cooling of the electrolytic solution below the boiling point of the electrolytic solution. Without the gas-liquid boundary distributed throughout the system inside each cell, evaporative cooling would only be possible within the bulk of the electrolytic solution by boiling the electrolytic solution. Without a liquid-gas boundary in the anode/cathode chambers of each cell, the vapor would be trapped/suspended in the liquid bulk, thereby reducing the conductivity of the electrolytic solution and further reducing its electrolysis efficiency.

For conventional electrolyzer systems that use electrolyzer membranes, these designs are typically high-pressure systems operating at 100 psi where the boiling point of the electrolytic solution is raised to approximately 170 degrees Celsius. Such high operating temperatures are generally not possible for a variety of reasons including the electrolyzer membranes and electrodes will fail/deteriorate at those temperatures. In fact, conventional membrane electrolyzers typically operate around 70 degrees Celsius to protect the electrolyzer membranes despite their high boiling temperatures at around 170 degrees Celsius. At 70 degrees Celsius and 100 psi, evaporative cooling is not feasible. In contrast, embodiments of the membraneless electrolyzers described herein may operate at 80 or 90 degrees Celsius, or hotter, at significantly lower pressure (e.g., 5 psi) where evaporative cooling is not only feasible, but can provide significant cooling. In various embodiments, the steady-state operating temperature range may extend to within 20 or even 10 degrees Celsius of the boiling point of the electrolytic solution.

For large scale commercial production of hydrogen gas, embodiments described herein densely stack the hydrogen electrolyzer cells into a large array, which is manifolded to separately collect the hydrogen and oxygen for further processing or exhaust. These manifolds equalize the backpressures throughout the stacks and array. With equalized backpressure across the individual cells, the boiling temperature of the electrolytic solution is constant throughout the stacks and array of hydrogen electrolyzer cells. This provides a built-in (passive) control mechanism to the evaporative cooling. If the temperature of the electrolytic solution in any one hydrogen electrolyzer cell (or stack of cells) begins to rise relative to the other hydrogen electrolyzer cells, then evaporative cooling in that cells (or stack) will inherently rise providing increased cooling within the anode/cathode chambers of the “hot” cells. This distributed, passive feedback mechanism operates to homogenize the operating temperature throughout a large, modular hydrogen electrolyzer system.

Due to the high latent heat of water, relative to its sensible heat, evaporative cooling can provide a significant thermally stabilizing effect near the boiling temperature of the electrolytic solution. The closer the operating temperature is to the boiling point (e.g., 110 degrees Celsius at 5 psi), the greater the evaporative cooling. While direct convection cooling may be actively managed, the evaporative cooling is passive with increasing effectiveness as the temperature approaches the boiling point. Accordingly, heat dissipation may be dynamically controlled between convection cooling and evaporative cooling in a hybrid cooling system. For example, evaporative cooling may account for 5%, or even significantly more, of the overall heat rejection. Of course, embodiments are contemplated herein where heat rejection may be single modal—provided entirely with direct convection cooling or entirely with evaporative cooling. In yet other embodiments, one or both of direct convection cooling and evaporative cooling may be used in connection with circulating a fluid (e.g., liquid coolant, water heated for extraneous purposes, etc.) through heat exchange paths formed into the cells themselves.

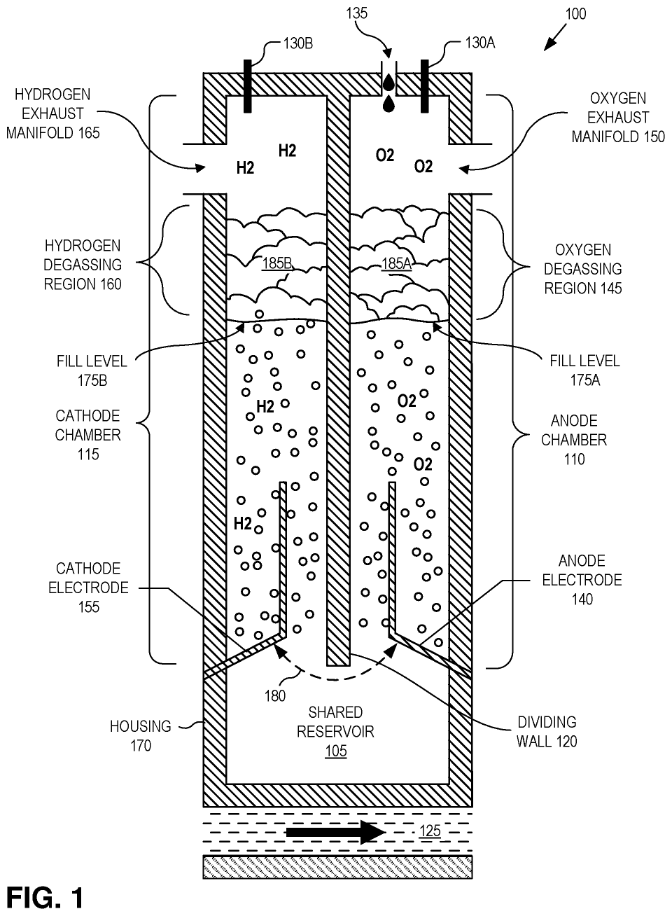

FIG. 1 illustrates a hydrogen electrolyzer cell 100, in accordance with an embodiment of the disclosure. The illustrated embodiment of cell 100 includes a shared reservoir 105, an anode chamber 110 separated from a cathode chamber 115 by a dividing wall 120, an integrated heat exchange path 125 (optional), gas sensors 130A and 130B, and a de-ionized (DI) water injection port 135. The illustrated embodiment of anode chamber 110 includes anode electrode 140, oxygen degassing region 145, and oxygen exhaust manifold 150. The illustrated embodiment of cathode chamber 115 includes cathode electrode 155, hydrogen degassing region 160, and hydrogen exhaust manifold 165. In the illustrated embodiment, a modular and extensible housing 170, which includes dividing wall 120, defines and encloses shared reservoir 105, anode chamber 110, cathode chamber 115, and heat exchange path 125. In other embodiments, heat exchange path 125 may be entirely omitted in favor of exterior surface convective cooling and/or internal evaporative cooling. For example, air may be blown across one or more (or all) exterior surfaces of housing 170 instead of integrating interior heat exchange path 125 within housing 170.

In one embodiment, the bulk of housing 170 is fabricated of an inexpensive, monolithic material. For example, housing 170 may be an injection molded thermoplastic (e.g., polypropylene). Of course other materials, compounds, or a combination of materials may be used depending upon a particular application. For example, housing 170 may be fabricated using a multilayer laminate construction combining multiple different materials having various desirable properties for heat resistance, mechanical strength, corrosion resistance, and/or thermal conductivity. Furthermore, housing 170 may be modular, meaning that it is assembled from multiple pieces, and extensible, meaning that it is formed from a repeating structure that facilitates stacking multiple instances of the single cell 100 to increase hydrogen production. In one embodiment, the sidewalls and dividing wall 120 are approximately 1 mm thick polypropylene. Of course, other thicknesses may be used. Not only is monolithic construction from thermoplastic inexpensive, but the metal electrodes and plastic housing bodies may be reconditioned or recycled to further reduce the lifetime cost. Reconditioning may be achieved via in-situ pressurized flushing of the stack with other chemicals.

When deployed, shared reservoir 105, anode chamber 110, and cathode chamber 115 are filled with an electrolytic solution to fill levels 175A & 175B (i.e., the liquid-gas boundary within each cell) that entirely bathes (i.e., submerges) anode electrode 140 and cathode electrode 155 within the electrolytic solution. The electrolytic solution is a stagnant or static bath and need not be pumped, or actively circulated or recycled through the cell or cell stack during electrolysis, though passive convection currents may arise as a side effect of internal heat dissipation or frothing during degassing. During operation, the differential backpressure between hydrogen exhaust manifold 165 and oxygen exhaust manifold 150 is regulated to be less than a threshold height differential of the electrolytic solution between anode chamber 110 and cathode chamber 115. The threshold height differential between fill levels 175A and 175B is selected to ensure that a differential backpressure doesn't result in dry exposure of either anode electrode 140 or cathode electrode 155. In other words, the backpressure differential between the exhaust manifolds may be closely regulated to ensure both anode electrode 140 and cathode electrode 155 always remain fully bathed in the electrolytic solution during electrolysis. Even temporary exposure of one of the electrodes can stop the electrolysis reaction. In various embodiments, the threshold height differential between fill levels 175A and 175B is equal to or less than 5 mm. In yet another embodiment, the threshold height differential between fill levels 175A and 175B is equal to or less than 3 mm (e.g., approximately a 0.0042 psi pressure imbalance).

In one embodiment, the electrolytic solution is an alkaline solution (base), such as aqueous potassium hydroxide (KOH) having 25% KOH and 75% water. Other electrolytes and/or electrolytic concentrations may be used. The electrolytic solution may include other additives such as antifouling agents or surfactants. The antifouling agents may be used to reduce biofouling, reduce chemical buildup, suppress undesirable side reactions, improve performance, or otherwise. The surfactants may be used to affect the diameter of the hydrogen/oxygen bubbles rising within cathode chamber 115 or anode chamber 110, or otherwise. As the water in the electrolytic solution is consumed during electrolysis (or due to evaporative cooling), it may be replenished by direction injection of deionized water via DI water injection port 135. In various embodiments, the water vapor lost through the exhaust manifolds may be captured in external condensers (e.g., refrigerated dryers) or separators (e.g., coalescing filters) that remove the water vapor from the hydrogen/oxygen gases. This removed water may then be mixed back into the electrolytic solution by a rehydration system to preserve the electrolyte concentration and recycle the water.

Divider wall 120 extends up from shared reservoir 105 and separates anode chamber 110 from cathode chamber 115 in the upper portion of cell 100. In one embodiment, dividing wall 120 extends equal to or below the bottom of the electrodes 140 and 155 exposed to the electrolytic solution. Dividing wall 120 terminates at the top of shared reservoir 105, which is open between the two chambers to permit transport of charged ions within the electrolytic solution under dividing wall 120 through shared reservoir 105 along conduction path 180 between anode electrode 140 and cathode electrode 155. In one embodiment, the height of shared reservoir 105 below dividing wall 120 is approximately equal to the width of each of anode chamber 110 and cathode chamber 115. Of course, other dimensions may be implemented. Dividing wall 120 is a solid non-permeable wall that blocks transport of charged ions forcing the conduction path 180 down around its distal/bottom end. Similarly, dividing wall 120 blocks mixing of the hydrogen and oxygen gases released during electrolysis. During operation, the oxygen and hydrogen gases bubble up, or evolve, in their respective chambers forming froths 185A and 185B (collectively referred to as froth 185) in oxygen degassing region 145 and hydrogen degassing region 160, respectively. The vertical orientation of anode chamber 110 and cathode chamber 115 facilitates this passive, buoyancy-driven separation of the oxygen and hydrogen gases during electrolysis without need of a dividing electrolysis membrane. The integrated degassing regions significantly reduces the need for expensive external phase separators/demisters that are corrosion resistant. The height of degassing regions may be selected to ensure froth 185 does not spill over into exhaust manifolds 150 and 165 for a desired operational drive current.

Integrating degassing region 145 within anode chamber 110 and degassing region 160 within cathode chamber 115 provides liquid-gas boundaries at fills levels 175 internal to the hydrogen electrolyzer cell 100. These liquid-gas boundaries permit vaporization of liquid-water to water vapor at these boundaries, thereby enabling evaporative cooling at temperatures below the boiling point of the electrolytic solution. This evaporative cooling is internal to the cell and proximate to the heat source for localized heat dissipation. The heat rejection path need not pass through the insulative barrier of housing 170. In embodiments where the steady-state temperature range extends up to the boiling point of the electrolytic solution, the vertical geometry and integrated degassing regions of anode chamber 110 and cathode chamber 115 leverage buoyancy driven separation of water vapor from the electrolytic solution to keep conduction path 180 clear of water vapor that would otherwise increase resistance and degrade efficiency. In other words, the water vapor rises quickly above the electrodes preserving the conductivity of conduction path 180 passing under the electrodes.

Embodiments of hydrogen electrolyzer cell 100 operate without need of expensive catalysts or membranes disposed between the electrodes as used in conventional membrane electrolyzers. Hydrogen electrolyzer cell 100 is membraneless because conduction path 180 for the transport of ions between the electrodes does not pass through an electrolyzer membrane that otherwise separates/isolates the two chambers from each other.

In the illustrated embodiment, anode electrode 140 and cathode electrode 155 are both fabricated from metal, such as nickel. In one embodiment, anode electrode 140 and cathode electrode 155 are fabricated from a metal mesh, such as a nickel metal mesh. A woven metal mesh, an expanded metal mesh, an expanded metal foam, a metal foil, a perforated metal, an expanded metal foil, nanostructured metal features on a foil, or otherwise may also be used. Anode electrode 140 and cathode electrode 155 may assume a variety of different sizes and shapes, such as metallic foams or other 3-dimensional structures. For example, the surfaces of the electrodes may be roughened to increase overall surface area in contact with the electrolytic solution. In one embodiment, anode electrode 140 and cathode electrode 155 may each be 2 cm long, though the electrodes need not be symmetrical. In yet other embodiments, the distal tips of electrodes may be folded over to keep more surface area of the electrodes closer to the bottom tip of dividing wall 120, thereby reducing the resistance of conduction path 180. Additionally, one or both of electrodes 140 and 155 may include integrated or coated catalysts, such as palladium, iridium, etc.

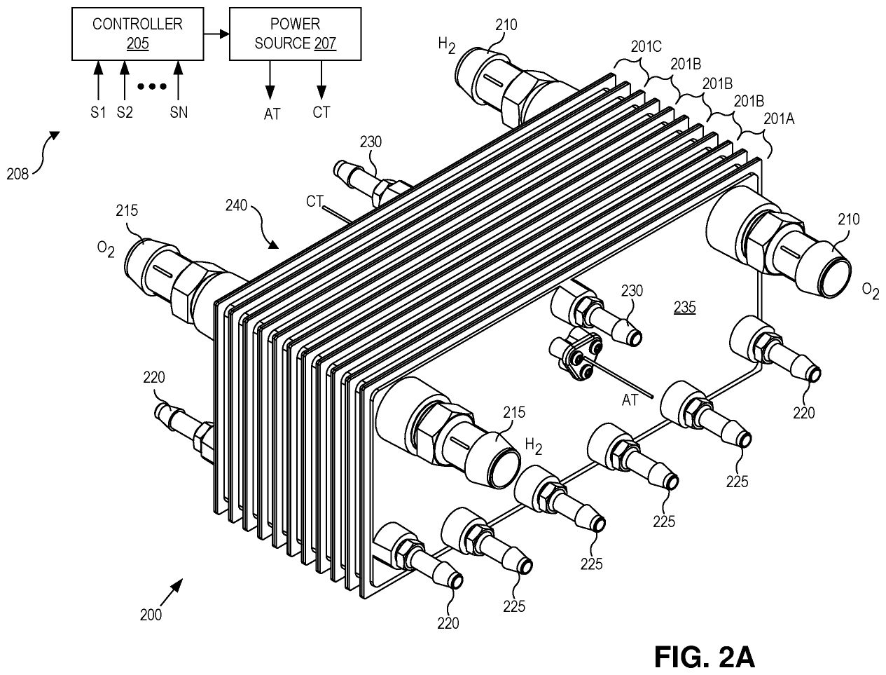

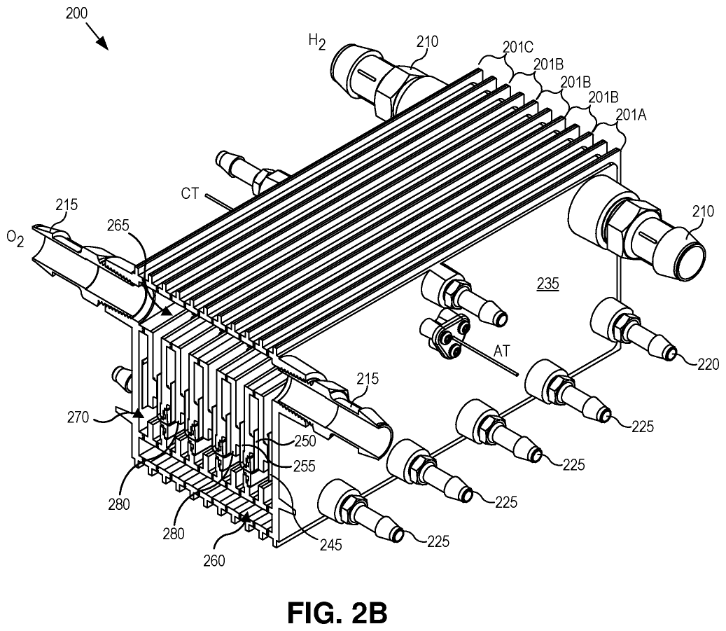

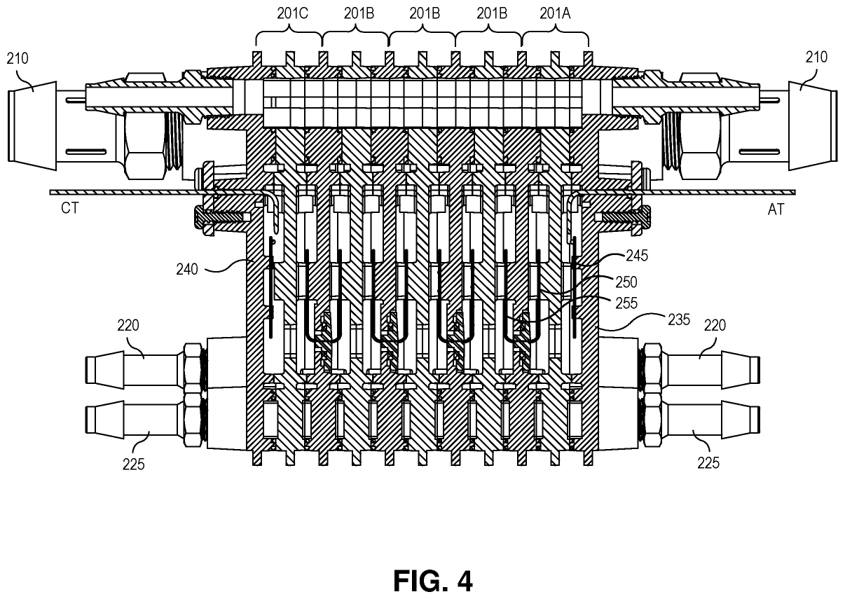

As discussed in more detail below in connection with FIG. 2B and FIG. 4, anode electrode 140 and cathode electrode 155 of adjacent electrolyzer cells in a stack of series connected cells may be implemented as joint electrodes formed from a single contiguous piece of metal (or metal mesh) bent into a U-shape or a V-shape that is embedded in and passes through the sidewall of housing 170. In one embodiment, the sidewalls of housing 170 are over-molded on top of the joint electrodes, to seal and separate the electrolytic solution in adjacent chambers.

As previously mentioned, oxygen exhaust manifold 150 is integrated into anode chamber 110 to export oxygen from cell 100, while hydrogen exhaust manifold 165 is integrated into cathode chamber 115 to export hydrogen gas from cell 100. Both oxygen exhaust manifold 150 and hydrogen exhaust manifold 165 are extensible for coupling to adjacent hydrogen electrolyzer cells in a stack. By integrating the exhaust manifolds into the extensible/modular structure of housing 170 itself, costs associated with stacking large numbers of hydrogen electrolyzer cell 100 are reduced.

Similar to the other extensible components, heat exchange path 125 may be optionally integrated into housing 170 and designed to connect with heat exchange paths 125 of adjacent cells stacked in series. In the illustrated embodiment, heat exchange path 125 is disposed adjacent to (e.g., under) shared reservoir 105 to exchange heat with the electrolytic solution. During regular operation, heat may be carried away from the electrolytic solution via circulating a heat exchange fluid (e.g., a water glycol coolant mixture, other liquid coolants, gaseous coolants, etc.) through heat exchange path 125. In an embodiment wherein housing 170 is fabricated of injection molded thermoplastic, the electrolytic solution may be cooled to maintain an operating temperature of approximately 95 degrees Celsius though other operating temperatures may be equal to or greater than 80, 90, 100, or 105 degrees Celsius. In one embodiment, the steady-state temperature range may range between 90-110 degrees Celsius. In other embodiments, the upper limit of the operating temperature is bound at or below the boiling point of the electrolytic solution and/or limited by the mechanical properties of the thermoplastic used to fabricate housing 170. For example, the upper limit of the operating temperature range may be 5, 10, 20, or 30 degrees below the boiling point of the electrolytic solution in various embodiments. In some embodiments, thermoplastics that are more expensive than polypropylene can handle higher temperatures before deformation, such as polysulfone. The exhaust manifolds may be operated at atmospheric pressure, or a backpressure applied to elevate the boiling point of the electrolytic solution and operate at higher temperatures and pressures depending upon the material or materials selected to form housing 170. Operating at higher temperatures and/or pressures may increase operating efficiency though may increase the cost of the material selection for housing 170 to withstand these higher temperatures and/or pressures. Pressure regulators may be coupled to the exhaust manifolds to manage gas flows and balance backpressures between the oxygen and hydrogen exhaust manifolds.

In the illustrated embodiment, anode chamber 110 includes a gas sensor 130A and cathode chamber 115 includes a gas sensor 130B adapted to monitor for cross mixing of hydrogen and oxygen gases resulting in a combustible vapor mixture. In one embodiment, gas sensors 130A and 130B are implemented using catalytic gas detectors such as a catalytic pellistor or otherwise. Gas sensors 130A and 130B may be coupled to a controller (e.g., controller 205) configured to shut down and/or automatically purge a contaminated exhaust manifold (e.g., purge with an inert gas) in case a combustible mixture of hydrogen and oxygen is detected, due to unintentional crossover of gas bubbles below dividing wall 120. While FIG. 1 illustrates a set of gas sensors 130A and B for use with the single cell 100, it should be appreciated that in a large stack-up of cells 100, gas sensors 130A and B may be inserted into the shared exhaust manifolds at the end of a serialized stack and thus shared across many individual cells 100. For example, FIG. 2A illustrates individual cells 201 serialized into a stack 200. In this embodiment, gas sensors 130B and 130C could be placed at ports 210 and 215, respectively. For cost efficiency reasons, these combustible gas sensors may be placed in the exhaust manifolds at the end of a stack, so that they can monitor for potentially combustible mixtures coming from multiple stacks 200 at once.

FIGS. 2A and 2B illustrate a hydrogen electrolyzer stack 200 including multiple hydrogen electrolyzer cells 201A, B and C (collectively referred to as cells 201) stacked in series, in accordance with an embodiment of the disclosure. FIG. 2A is a perspective view illustration of stack 200 while FIG. 2B includes a side cutout illustrating internal details of stack 200. Cells 201 each represents one possible implementation of hydrogen electrolyzer cell 100 illustrated in FIG. 1. The illustrated embodiment of stack 200 includes five cells 201, an anode terminal (AT), a cathode terminal (CT), hydrogen manifold ports 210, oxygen manifold ports 215, fill/drain ports 220, heat exchange ports 225, DI water ports 230, anode end panel 235, and cathode end panel 240.

As illustrated, cells 201 may be stacked in series to form stack 200. Although FIGS. 2A and 2B illustrated just five cells 201 coupled in series, it should be appreciated that more or less cells 201 may be stacked in series. The interior cells 201B may be substantially identical, repeatable structures sandwiched between end cells 201A and 201C. The cells 201 may be mechanically connected with fasteners and sealed with gaskets (e.g., o-rings), hot-plate welded to avoid the cost associated mechanical fasteners and gaskets, or connected and sealed using other techniques (e.g. ultrasonic welding, vibration welding, infrared welding, laser welding, etc.) or adhesives.

In one embodiment, a power source 207 is a direct current (DC) to DC converter that couples to CT and AT to apply a bias voltage across the series connected cells 201. Power source 207 may further include various intermittent power sources such as solar cells or wind turbines. A controller 205 is coupled to power source 207 and stack 200. Collectively, controller 205 and power source 207 may be referred to as a control system 208. Controller 205 may include hardware and/or software logic and a microprocessor to orchestrate operation of power source 207 and stack 200. In the illustrated embodiment, controller 205 monitors various sensor signals S1, S2 . . . SN from stack 200 and uses these feedback sensor signals to control power source 207. The sensor signals may include temperature readings, gas sensor readings, voltage readings, electrolyte level readings, etc. sourced from stack 200. During regular operation, controller 205 applies a forward bias potential across CT and AT. However, in some instances, controller 205 may periodically, or on-demand, short or reverse bias CT and AT to recondition the anode and cathode electrodes. Short circuiting or reverse biasing may be particularly beneficial for anode electrode 140 due to the buildup of surface layer nickel oxides. Reverse biasing may be at a sufficiently low voltage that does not cause electrolysis and gas production, while still reconditioning the electrodes.

Correlating FIG. 2A to FIG. 1, fill/drain ports 220 connect to shared reservoir 105 of cells 201 to fill or drain the electrolytic solution. Heat exchange ports 225 (optional) couple to heat exchange path 125 of cells 201 to circulate a heat exchange fluid through stack 200 for temperature regulation. Hydrogen manifold ports 210 connect to hydrogen exhaust manifold 165 of each cell 201 to export hydrogen gas from the stack 200 while oxygen manifold ports 215 connect to oxygen exhaust manifold 150 of each cell 201 to export oxygen gas from stack 200. DI water ports 230 couple to DI water injection port 135 of each cell 201. Finally, cathode terminal CT connects directly to cathode electrode 155 of a first end cell 201C while anode terminal AT connects directly to anode electrode 140 of the other end cell 201A.

FIG. 2B includes a side cutout of hydrogen electrolyzer stack 200 illustrating internal details, in accordance with an embodiment of the disclosure. Anode terminal AT directly connects to anode electrode 245 of end panel 235 of end cell 201A. As illustrated, cathode electrode 250 of end cell 201A and anode electrode 255 of adjacent interior cell 201B form a joint electrode having a U-shape that is embedded in and passes through the shared sidewall between these adjacent cells. Half of the joint electrode is a cathode for end cell 201A while the other half is an anode for the adjacent interior cell 201B. This U-shaped joint electrode is illustrated in greater detail in FIG. 4. Of course, other cross-sectional shapes, such as a V-shape, may be implemented with the joint electrodes.

Returning to FIG. 2B, the heat exchange path of each cell 201 aligns to and joins with the heat exchange path of its adjacent cells to form an extensible heat exchange path 260 that runs the length of stack 200 and connects to heat exchange ports 225. Similarly, the oxygen exhaust manifold of each cell 201 aligns to and joins with the oxygen exhaust manifold of its adjacent cells to form an extensible oxygen exhaust manifold 265 that runs the length of stack 200 and connects to oxygen manifold ports 215. A similar structure applies to the hydrogen exhaust manifold. Shared reservoir 270 is also extensible when adding cells. In one embodiment, equalization ports are formed through sidewalls of the cells 201 to allow the electrolytic solution to be filled via fill/drain ports 220 (and/or DI water ports 230), spread to each cell 201, and fill to a common fill level 175 throughout stack 200. Finally, FIG. 2B further illustrates dividing walls 280 (not all are labelled in FIG. 2B) that extend down to the top of the extensible shared reservoir 270.

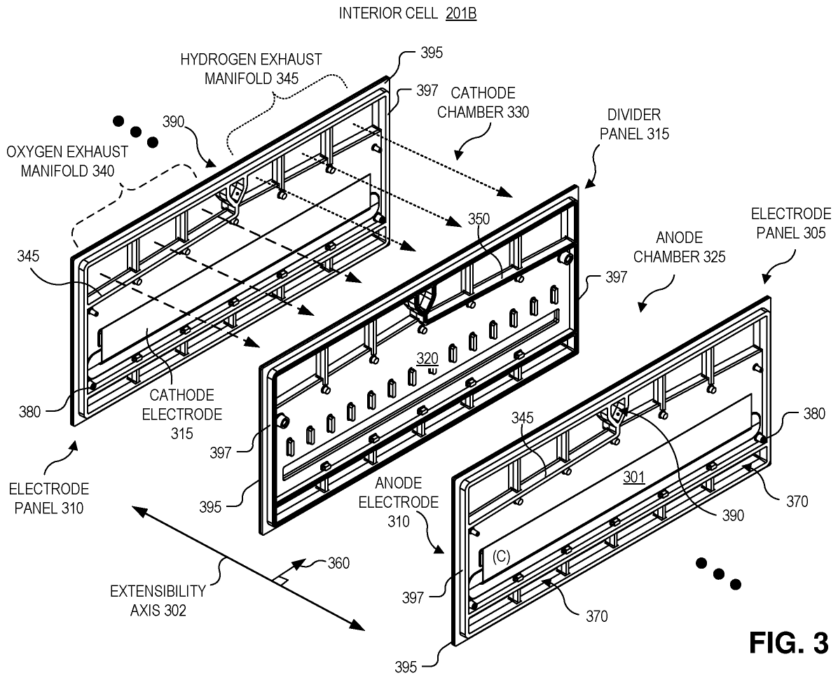

FIG. 3 illustrates how hydrogen electrolyzer cells 201 are extensible and stackable using a modular panel design, in accordance with an embodiment of the disclosure. The housing of interior cell 201B is assembled from two electrode panels 305 and 310 sandwiching a divider panel 315. Since cell 201B is an interior cell, its outer electrode panels 305 and 310 are shared by adjacent cells in stack 200. Multiple interior cells 201B may be stacked on either side of the illustrated interior cell 201B along extensibility axis 302. In other words, cathode electrode 301 is the cathode of an adjacent cell 201 (not illustrated in FIG. 3) while anode electrode 310 (hidden from view) and cathode electrode 315 form the electrodes of the instant interior cell 201B illustrated in FIG. 3. Thus, electrode panels 305 and 310 include embedded joint electrodes while divider panel 315 forms a dividing wall 320 between anode chamber 325 and cathode chamber 330. The joint electrodes may also be referred to as “bipolar electrodes” similar to bipolar plate electrodes used in conventional alkaline electrolyzers where one side of the electrode is negative and the other side is positive.

Electrode panels 305, 310 and divider panel 315 may be fabricated from a variety of materials; however, in one embodiment, they are fabricated from a common material, such as injection molded thermoplastic. The panels may be sealed together to form the housing structure of each cell using gaskets, hot-plate welding, adhesives, or otherwise. The extensibility comes from stacking multiple sets of panels together. In other embodiments, large stacks of cells may be fabricated using a one-step manufacturing process (rather than assembled from a set of pieces). For example, a stack of cells may be cast as a single part, 3D printed, etc.

FIG. 3 also illustrates flanges 395 that extend along the perimeter of each electrode panel 305/310 and divider panel 315 and skirt the outer ledges 397. Ledges 397 are the raised locations for sealing adjacent panels using any of the aforementioned techniques. Flanges 395 provide a structural extension for holding, aligning, and applying mechanical pressure during the assembly and sealing (e.g., hot-plate welding) processes. Ledges 397 may be melted together or include grooves for housing seals (e.g., gaskets, adhesive, etc.). Flanges 395 may also serve a dual purpose of operating as a cooling fin or turbulator to induce turbulent fluid flow over the exterior surfaces of a stack of cells (e.g., stacks 501) when exterior convective cooling is applied. In other words, flanges 395 may increase the heat transfer efficiency of direct convection cooling applied to the housings of cells 201. Since flanges 395 extend around all four sides of each cell 201, they promote cooling on all four exterior edges. Additionally, when hydrogen electrolyzer cells are ganged into stacks and arrays, flanges 395 may provide physical offsets between adjacent cells that define cooling channels to permit cooling air to penetrate to, and pass across, interior cells disposed deep within the stack/array. Since these flanges are already present to aid manufacturing, a single component is advantageously leveraged for multiple purposes both during manufacturing and operation.

Electrode panels 305, 310 and divider panel 315 all include oxygen exhaust manifold 340 disposed laterally (along axis 360) to hydrogen exhaust manifold 345. When the panels are sealed together into stack 200, oxygen exhaust manifold 340 and hydrogen exhaust manifold 345 both extend through the entire stack 200. Ridges 345 press against dividing panel 315 sealing oxygen exhaust manifold 340 off from cathode chambers 330 while ridges 350 press against electrode panel 305 sealing hydrogen exhaust manifold 345 off from anode chambers 325. Ridges 345 and 350 alternate from one panel to the next in the stack up to ensure oxygen and hydrogen exhaust gases do not mix between their respective exhaust manifolds.

FIG. 3 further illustrates how each electrode panel 305 and 310 may further include an electrolyte equalization port 380 connecting one shared reservoir to another shared reservoir of an adjacent cell. These electrolyte equalization ports are passages through electrode panels 305 and 310 in the shared reservoir region to permit passage of the electrolyte solution during filling and draining and to help equalization of fill level 175 across multiple cells 201. To reduce the likelihood of shunt current paths between adjacent shared reservoirs, the electrolyte equalization ports are staggered side-to-side between electrode panels 305 and 310 to introduce a circuitous, high resistance electrical path between adjacent shared reservoirs.

FIG. 3 illustrates DI channel 390 that is formed when sandwiching the panels together. DI channel 390 couples to DI water ports 230 at either end of a stack of panels to replenish water consumed in each cell during electrolysis and/or rehydrate liquid water condensed from evaporation back into the electrolytic solution. A DI water injection port 135 may be a hole or embedded tube disposed on an interior surface of each electrode panel 305/310 within DI channel 390, or a notch disposed on a surface edge of each electrode panel 305/310 within DI channel 390. DI water injection ports 135 may share a common DI channel 390, but either feed into only anode chambers 110 or only cathode chambers 115. Including DI water injection ports 135 into both anode and cathode chambers may require separate DI channels 390, one-way valves, or another mechanism to prevent combustible mixing of oxygen and hydrogen gases within DI channel 390.

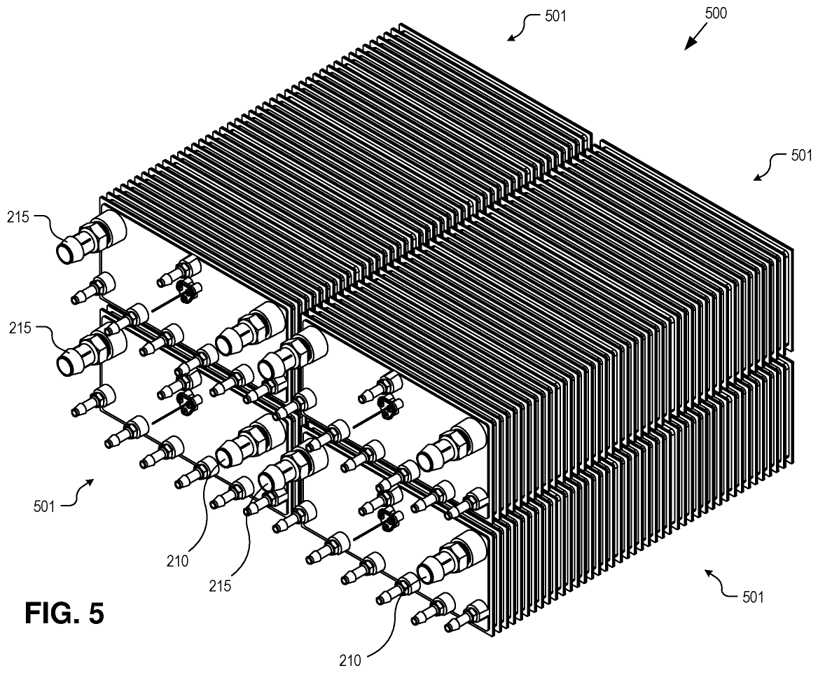

FIG. 5 is a perspective view illustration of an array 500 of stacks 501 of hydrogen electrolyzer cells coupled for large scale hydrogen production, in accordance with an embodiment of the disclosure. For example, a 1 MW electrolyzer array may include approximately 1400 stacks 501 with each stack 501 extending approximately 6 feet long for a total of 200,000 individual cells in the overall array 500. In a large array 500, hydrogen manifold ports 210 and oxygen manifold ports 215 may be connected to large external manifolds (not illustrated) from which water vapor due to evaporative cooling is condensed. Pressure regulators and gas sensors may be disposed in these external manifolds to collectively regulate backpressures, and/or monitor operation of stacks 501.

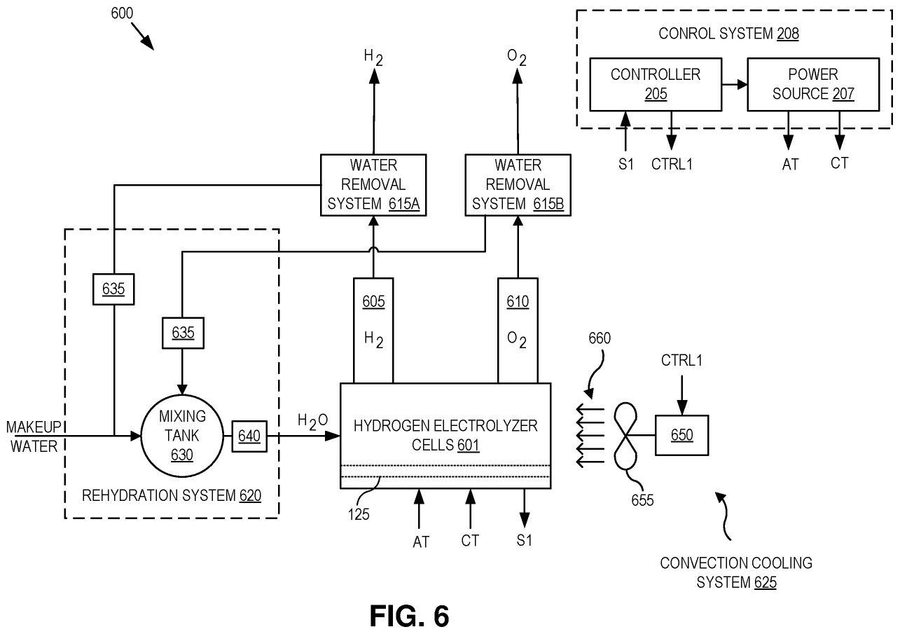

FIG. 6 is a functional block diagram illustrating components for hybrid heat management of a hydrogen electrolyzer system 600, in accordance with an embodiment of the disclosure. The illustrated system 600 includes hydrogen electrolyzer cells 601, a shared hydrogen exhaust manifold 605, a shared oxygen exhaust manifold 610, water removal systems 615A and 615B, a rehydration system 620, a convection cooling system 625, and control system 208. The illustrated embodiment of rehydration system 620 includes a mixing tank 630, drain pump(s) 635, and feed pump 640. The illustrated embodiment of convection cooling system 625 includes a motor 650 and fan 655. The illustrated embodiment of hydrogen electrolyzer cells 601 includes an optional heat exchange path 125, which could be coupled with an external heat exchanger (not illustrated) in some embodiments.

Hydrogen electrolyzer cells 601 may represent a stack 200 or an array 500 of cells 100 or 201 coupled to and sharing a common hydrogen exhaust manifold 605 and a common oxygen exhaust manifold 610. Water removal systems 615 may be implemented using a variety of technologies, such as for example, coalescent filters, condensers, etc. Water removal systems 615 separate/condense the water vapor back to liquid form, which is pumped into mixing tank 630 and from there returned to hydrogen electrolyzer cells 601 via a pump 640. In one embodiment, pumps 635 and 640 are peristaltic pumps. Rehydration system 620 is coupled between water removal systems 615 and hydrogen electrolyzer cells 601 to mix the liquid water back into the electrolytic solution to ensure the electrodes are not boiled dry and to maintain the electrolyte concentration. However, it should be appreciated that pump 640 is not a recirculation pump in the conventional senses as it is not actively circulating the electrolytic solution, which is stagnant, but rather pump 640 is merely returning lost water due to electrolysis and evaporation.

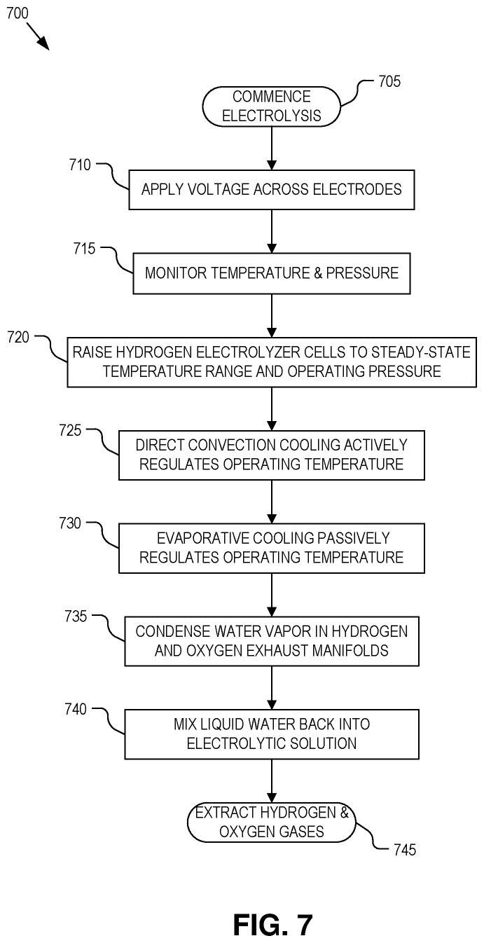

FIG. 7 is a flow chart illustrating a process 700 of hybrid heat management of hydrogen electrolyzer system 600, in accordance with an embodiment of the disclosure. Process 700 dynamically leverages direct external convection cooling with internal evaporative cooling to maintain steady-state electrolysis. The order in which some or all of the process blocks appear in process 700 should not be deemed limiting. Rather, one of ordinary skill in the art having the benefit of the present disclosure will understand that some of the process blocks may be executed in a variety of orders not illustrated, or even in parallel.

In a process block 705, electrolysis is commenced by the application of a voltage across the anode electrodes 140 and cathode electrodes 155 (process block 710). The bias voltage drives an electrical current along conduction path 180 through the electrolytic solution resulting in the production of hydrogen gas about cathode electrode 155 in cathode chamber 115 and oxygen gas about anode electrode 140 in anode chamber 110 of each cell. Buoyancy causes the hydrogen gas to rise within cathode chambers 115 to hydrogen degassing regions 160 and vent out hydrogen exhaust manifolds 165, which are connected to (or integrated with) hydrogen exhaust manifold 605. Hydrogen exhaust manifold 605 is shared across many cells 100 or 201 in the stack or array. Correspondingly, the oxygen gas rises within anode chambers 110 to oxygen degassing regions 145 and vented out oxygen exhaust manifolds 150, which are connected to (or integrated with) oxygen exhaust manifold 610. Oxygen exhaust manifold 610 is shared across many cells 100 or 201 in the stack or array.

As electrolysis proceeds, heat builds up within hydrogen electrolyzer cells 601. In a process block 715, the temperature (and pressure) within cells 601 may be monitored by control system 208 via feedback signal(s) S1. Eventually cells 601 will reach their steady-state temperature range, at which point heat must be rejected from the system in order to maintain steady-state electrolysis (process block 720). Since system 600 includes hybrid heat management, heat rejection may be accomplished via direct external convection cooling, via internal evaporative cooling, via fluid coolant, or any combination of these (or other cooling techniques discussed below). In one embodiment, the steady-state operating temperature range is between 80 degrees Celsius and the boiling point of the electrolytic solution (e.g., 110 degrees Celsius). In yet other embodiments, the steady-state operating temperature range is between 90, 95, 100, or 105 degree Celsius and the boiling point of the electrolytic solution. In yet other embodiments, the steady-state operating temperature may range between 90 to 100 degrees at the low end and approximately 95, 100, or 105 degrees at the upper end.

In a process block 725, direct external convection cooling may be actively initiated under the control of control system 208. Control system 208 may commence convection cooling when the operating temperature exceeds a threshold level (e.g., 80 or 90 degrees Celsius). In the illustrated embodiment, convection cooling system 625 blows cooling air 660 directly on and across the housings of cells 601 (or 100, 201) to provide direct external convection cooling to cells 601. Convection cooling system 625 is coupled to control system 208 via control signal CTRL1, which may actively manage the speed of fan 655 based upon temperature feedback signal S1 from cells 601. Signal S1 may represent a single temperature signal or a plurality of temperature signals distributed throughout cells 601. Thus, excess heat within the electrolytic solution is conducted through housings 170 and carried away via direct external convection.

In a process block 730, evaporative cooling automatically/passively commences as the operating temperature of the electrolytic solution rises. The higher the operating temperature, the greater portion of heat rejection is provided internally by evaporative cooling. Evaporative cooling may be provided within each of the cathode chambers 115 and/or anode chambers 110 of each hydrogen electrolyzer cell. Heat is dissipated away in the water vapor rising from the liquid-gas boundary and exported out of the cells with the hydrogen and oxygen gases in hydrogen exhaust manifold 605 or oxygen exhaust manifold 610, respectively.

In a process block 735, the exported water vapor in hydrogen exhaust manifold 605 and oxygen exhaust manifold 610 is cooled and condensed or separated by water removal systems 615A and 615B, respectively, back into liquid water. This liquid water is pumped into mixing tank 630 via pumps 635 where it is then returned to cells 601 via pump 640 and mixed back into the electrolytic solution. During the electrolysis operation, the produced hydrogen is captured for productive use (process block 745). The oxygen may also be captured for productive use, or discharged to the atmosphere.

While the hybrid heat management process discussed above includes the use of both direct external convection cooling and internal evaporative cooling, it should be appreciated that this hybrid process is dynamic and may include instances of using direct external convection cooling at cooler temperatures that do not result in significant or any evaporative cooling. Similarly, this hybrid process may include instances of using evaporative cooling at a steady-state temperature range that operates closer to the boiling point of the electrolytic solution to the exclusion of external convection cooling (or other types of cooling). In yet other embodiments, one or both of direct external convection cooling and/or internal evaporative cooling may be used in connection with one or more other forms of cooling including actively flowing a coolant through heat exchange paths 125, radiative cooling, conduction cooling, etc.

The processes explained above may be described in terms of computer software and hardware logic. The techniques or logic described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. A hydrogen electrolyzer system, comprising:
hydrogen and oxygen exhaust manifolds;
a plurality of hydrogen electrolyzer cells each coupled to, and sharing, the hydrogen and oxygen exhaust manifolds, wherein each of the hydrogen electrolyzer cells includes:
an anode chamber including an anode electrode bathed in an electrolytic solution, the anode chamber vented to the oxygen exhaust manifold; and
a cathode chamber including a cathode electrode bathed in the electrolytic solution, the cathode chamber vented to the hydrogen exhaust manifold; and
a control system coupled to the anode and cathode electrodes, the control system including logic that when executed causes the hydrogen electrolyzer system to perform operations including:
applying a voltage across the anode and cathode electrodes to produce a hydrogen gas in the hydrogen exhaust manifold and an oxygen gas in the oxygen exhaust manifold during a steady-state electrolysis of the hydrogen electrolyzer system; and
maintaining the electrolytic solution in the hydrogen electrolyzer cells within a steady-state temperature range during the steady-state electrolysis based at least in part on an evaporative cooling of the electrolytic solution.

2. The hydrogen electrolyzer system of claim 1, wherein maintaining the electrolytic solution within the steady-state temperature range comprises:
evaporating the electrolytic solution within one or both of the anode or cathode chambers during the steady-state electrolysis.

3. The hydrogen electrolyzer system of claim 2, wherein evaporating the electrolytic solution within the one or both of the anode or cathode chambers during the steady-state electrolysis comprises:
vaporizing some of the electrolytic solution into a water vapor within the anode or cathode chambers at a liquid-gas boundary maintained within the anode or cathode chambers; and
exporting a first portion of the water vapor with the hydrogen gas via the hydrogen exhaust manifold and a second portion of the water vapor with the oxygen gas in the oxygen exhaust manifold.

4. The hydrogen electrolyzer system of claim 1, wherein maintaining the electrolytic solution within the steady-state temperature range further comprises:
boiling at least a portion of the electrolytic solution within the anode or cathode chambers.

5. The hydrogen electrolyzer system of claim 1, further comprising:
one or more water removal systems coupled to one or both of the hydrogen or oxygen exhaust manifolds and configured to condense a water vapor received from the hydrogen or oxygen exhaust manifolds into a liquid water; and
a rehydration system coupled between the one or more water removal systems and the hydrogen electrolyzer cells to mix the liquid water back into the electrolytic solution.

6. The hydrogen electrolyzer system of claim 5, wherein the one or more water removal systems comprise a pair of condensers or water separators each coupled to a different one of the hydrogen and oxygen exhaust manifolds.

7. The hydrogen electrolyzer system of claim 1, further comprising:
a convection cooling system coupled to the control system and configured to blow cooling air directly on housings of the hydrogen electrolyzer cells,
wherein maintaining the electrolytic solution in the hydrogen electrolyzer cells within the steady-state temperature range during the steady-state electrolysis is further achieved at least in part via a direct convection cooling of the housings of the hydrogen electrolyzer cells.

8. The hydrogen electrolyzer system of claim 7, wherein hydrogen electrolyzer cells are arranged into a stack and each of the housings of the hydrogen electrolyzer cells includes:
a flange encircling a perimeter of a given hydrogen electrolyzer cell, the flange adapted for holding and aligning the housings during assembly of the stack,
wherein the flanges are adapted to promote a turbulence in the cooling air from the convection cooling system.

9. The hydrogen electrolyzer system of claim 1, wherein the electrolytic solution is not actively circulated through the cathode and anode chambers.

10. The hydrogen electrolyzer system of claim 1, wherein the electrolytic solution is a shared solution that at least partially fills both of the cathode and anode chambers, and wherein the hydrogen electrolyzer cells comprise membraneless electrolyzers where the cathode and anode chambers are not separated from each other by an electrolysis membrane.

11. A method of electrolysis, the method comprising:
applying a voltage across anode and cathode electrodes bathed in an electrolytic solution disposed within a plurality of hydrogen electrolyzer cells;
venting a hydrogen gas produced in cathode chambers of the hydrogen electrolyzer cells to a hydrogen exhaust manifold;
venting an oxygen gas produced in anode chambers of the hydrogen electrolyzer cells to an oxygen exhaust manifold;
evaporating a portion of the electrolytic solution within at least one of the cathode or anode chambers; and
maintaining the electrolytic solution in the hydrogen electrolyzer cells within a steady-state temperature range during the electrolysis based at least in part on an evaporative cooling of the electrolytic solution within the hydrogen electrolyzer cells.

12. The method of claim 11, further comprising:
blowing cooling air directly on housings of the hydrogen electrolyzer cells,
wherein maintaining the electrolytic solution in the hydrogen electrolyzer cells within the steady-state temperature range during the electrolysis is further achieved at least in part via a direct convection cooling of the housings of the hydrogen electrolyzer cells.

13. The method of claim 12, further comprising:
increasing an amount of the evaporative cooling relative to the direct convention cooling as an operating temperature of the hydrogen electrolyzer cells rises.

14. The method of claim 11, wherein evaporating the portion of the electrolytic solution within at least one of the cathode or anode chambers comprises:
vaporizing the portion of the electrolytic solution into water vapor within the anode or cathode chambers at a liquid-gas boundary of the electrolytic solution maintained within the anode or cathode chambers.

15. The method of claim 11, wherein the steady-state temperature range of the electrolytic solution is greater than 90 degrees Celsius.

16. The method of claim 11, further comprising:
boiling at least a portion of the electrolytic solution within the anode or cathode chambers to maintain the electrolytic solution in the hydrogen electrolyzer cells within the steady-state temperature range during the electrolysis.

17. The method of claim 11, further comprising:
venting a first water vapor produced within the cathode chambers due to the evaporating out the hydrogen exhaust manifold with the hydrogen gas; and
venting a second water vapor produced within the anode chambers due to the evaporating out the oxygen exhaust manifold with the oxygen gas.

18. The method of claim 17, further comprising:
condensing the first water vapor vented out the hydrogen exhaust manifold with the hydrogen gas into a liquid water with a condenser or water separator coupled to the hydrogen exhaust manifold.

19. The method of claim 18, further comprising:
capturing the liquid water condensed from the first water vapor; and
mixing the liquid water back into the electrolytic solution within the hydrogen electrolyzer cells.

20. The method of claim 11, wherein the electrolytic solution is not actively circulated through the cathode and anode chambers during the electrolysis, the electrolytic solution is a shared solution that at least partially fills both of the cathode and anode chambers, and the hydrogen electrolyzer cells comprise membraneless electrolyzers where the cathode and anode chambers are not separated from each other by an electrolysis membrane.

21. The method of claim 11, further comprising:
maintaining a first equal backpressure in all of the cathode chambers via venting all of the cathode chambers to a common hydrogen exhaust manifold;
maintaining a second equal backpressure in all of the anode chambers via venting all of the anode chambers to a common oxygen exhaust manifold; and
leveraging the first and second equal backpressures to achieve a substantially uniform operating temperature of the electrolytic solution within all of the hydrogen electrolyzer cells based on the evaporative cooling.
